(19) United States
(12) Patent Application Publication
(10) Pub. No.: US 2026/0098155 A1
(43) Pub. Date: Apr. 9, 2026

(54) COMPOSITION INCLUDING SILICONE AND METHOD OF FORMING

(71) Applicants: SAINT-GOBAIN ABRASIVES, INC., Worcester, MA (US); SAINT-GOBAIN SURFACE SOLUTIONS FRANCE, Conflans-Saint-Honorine (FR)

(72) Inventors: Shuai LIANG, Southborough, MA (US); Cassandra T. TUBBS, Boylston, MA (US); Huijun GUO, Hangzhou (CN); Hua WANG, Northbridge, MA (US); Ligang ZHAO, Düsseldorf (DE); Xiaolong SUN, Hangzhou (CN); Jinsheng WU, Lexington, MA (US); Cheng FU, Hangzhou (CN); Mark W. SIMON, Sutton, MA (US)

(21) Appl. No.: 19/353,462

(22) Filed: Oct. 8, 2025

(30) Foreign Application Priority Data
Oct. 8, 2024 (CN) 202411398759.X

(51) Int. Cl. C08L 83/04; C08K 3/26; C09J 183/04; C09K 3/10

(52) U.S. Cl. CPC C08L 83/04; C08K 3/26; C09J 183/04; C09K 3/1018; C08K 2003/265; C08K 2201/005; C08K 2201/011; C08K 2201/014; C08L 2205/05; C09K 2003/1034

(57) ABSTRACT

The subject application relates to a composition including a first component including a silane-modified silicone resin, a second component including a silane-modified polyether, and filler having a multi-model particle size distribution. The first component may be greater than 30 wt % of the composition.

### CROSS-REFERENCE TO RELATED APPLICATION(S)

This application claims priority to and the benefit of Chinese Patent Application No. 202411398759.X, entitled “COMPOSITION INCLUDING SILICONE,” by Shuai LIANG et al., filed Oct. 8, 2024, which is assigned to the current assignee hereof and incorporated herein by reference in its entirety.

### FIELD OF THE DISCLOSURE

The present disclosure relates to a composition including silicone and particularly, to a curable composition including silicone.

### BACKGROUND

Sealants, such as room temperature vulcanizing (RTV) silicones, are widely used in applications of construction, transportation, electronics, and others. RTV silicones may age over time before use, which adversely affects vulcanization rates and strength of sealants. The industry continues to seek improved sealant compositions.

### BRIEF DESCRIPTION OF THE DRAWINGS

Embodiments are illustrated by way of example and are not limited to the accompanying figures.

FIG. 1 includes a flow chart illustrating a process for forming a sealant according to embodiments described herein.

FIG. 2 includes a histogram of maximum (dG′/dt) over time of aging of different samples.

FIG. 3 includes a histogram of storage modulus over time of aging of different samples.

FIG. 4 includes a histogram of viscosity over time of aging of different samples.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multi-component composition including a silicone resin. The composition may be curable and used for a sealant, an adhesive, or the like. The composition may have improved property, such as complex viscosity, storage modulus, curing rate, or the like, or any combination thereof. In particular, the composition may have improved shelf life.

In an embodiment, the composition may include a first component including a silane-modified silicone resin. In an exemplary implementation, the silane-modified silicone resin may constitute the base polymer of the composition. In a particular embodiment, the silane-modified silicone resin may have a particular number average molecular weight that may facilitate improved property and/or performance of the composition. In an example, the silane-modified silicone resin may include a number average molecular weight of at most 60,000 g/mol, such as at most 55,000 g/mol, at most 50,000 g/mol, at most 45,000 g/mol, at most 40,000 g/mol, at most 35,000 g/mol, at most 30,000 g/mol, or at most 25,000 g/mol. In another example, the number average molecular weight of the silane-modified silicone resin may be at least 15,000 g/mol, at least 20,000 g/mol, at least 25,000 g/mol, at least 30,000 g/mol, at least 35,000 g/mol, at least 40,000 g/mol, or at least 45,000 g/mol. Moreover, the silane-modified silicone resin may include a number average molecular weight in a range including any of the minimum and maximum values noted herein. For example, the number average molecular weight of the silane-modified silicone resin may be in a range from 15,000 g/mol to 60,000 g/mol or in a range from 25,000 g/mol to 45,000 g/mol. Number average molecular weight may be detected by using conventional Gel Permeation Chromatography (GPC). Shimadzu Prominence LC-20AD system may be connected with a RID-20A refractive Index Detector for the detection. Equipment with equivalent functions may be used. Toluene may be used as a mobile phase. The flow rate may be set to 1 ml/min. The calibration curve may be created by 10 different polystyrene reference materials with known number average molecular weight.

In an embodiment, the silane-modified silicone resin may include a repeating unit of a formula of [(Si(CH₃)₂O]. In a further embodiment, the silane-modified silicone resin may include a particular number of the repeating unit [(Si(CH₃)₂O] that may facilitate improved property and/or performance of the composition. In an example, the number of the repeating unit may be at least 5, at least 10, at least 25, at least 50, at least 100, at least 300, or at least 500. In another example, the number of the repeating unit may be at most 5000, such as at most 4000, at most 3000, at most 2000, at most 1000, at most 500, or at most 200. Moreover, the number of the repeating unit of [(Si(CH₃)₂O] may be in a range including any of the minimum and maximum values noted herein.

In another embodiment, the silane-modified silicone resin may include a terminal alkoxy group. For example, the silane-modified silicone resin may include the terminal alkoxy silanol group directly bonded to an oxygen atom that may be directly bonded to a silicon atom. In an embodiment, the terminal alkoxy group may include methoxy group. In a particular example, the terminal alkoxy group may consist of methoxy group. In a further embodiment, the silane-modified silicone resin may include a terminal alkoxy silano group, such as a terminal methoxy silanol group. In a particular example, the terminal alkoxy silanol group may include a trimethoxy silano group. In a further embodiment, the first component may include alkoxy-terminated polydimethylsiloxane. In a particular example, the first component may include trimethoxy-terminated polydimethylsiloxane. In a more particular example, the trimethoxy-terminated polydimethylsiloxane may include a direct bond between the terminal trimethoxy siloxane group and the repeating unit of [(Si(CH₃)₂O]. In another particular embodiment, the silane-modified silicone resins may consist of trimethoxy-terminated polydimethylsiloxane. As appreciated by a skilled artisan, functional groups or capping groups may be detected by using ¹H-NMR, ²⁹Si-NMR, ¹³C-NMR, or combinations thereof. Instruments like nuclear magnetic resonance spectroscopy (NMR), such as Bruker NEO 600 MHz or a functional equivalent apparatus, may be used.

In another embodiment, the composition may include a particular first content of the first component that may facilitate improved property and/or performance of the composition. For example, the first component may have a first content of greater than 30 wt % for a total weight of the composition, such as at least 32 wt %, at least 34 wt %, at least 35 wt %, at least 37 wt %, at least 38 wt %, at least 40 wt %, at least 42 wt %, or at least 44 wt % for a total weight of the composition. In another example, the first content may be at most 56 wt % of the total weight of the composition, such as at most 54 wt %, at most 53 wt %, at most 51 wt %, at most 49 wt %, at most 46 wt %, at most 45 wt %, or at most 43 wt % of the total weight of the composition.

Moreover, the first content of the first component may be in a range including any of the minimum and maximum percentages noted herein. In a further embodiment, the silane-modified silicone resin may be in any of the first content noted herein. In a further embodiment, the content of the first component may be no less or greater than a content of any other component of the composition.

In an embodiment, the composition may include a second component including a silane-modified prepolymers, such as silane-modified polyether. In another embodiment, the second component may function as a crosslinker. In a further embodiment, the second component may include silane-modified polyether having a particular number average molecular weight that may facilitate improved property and/or performance of the composition. In an example, the silane-modified polyether may have a number average molecular weight of at least 4000, such as at least 5000, at least 6500, at least 7200, at least 8000, at least 9000, at least 10000, at least 11200, at least 12500, at least 13500, at least 14800, at least 15600, at least 16100, or at least 16500. In another example, the silane-modified polyether may have a number average molecular weight of at most 25000, such as at most 23600, at most 21700, at most 21000, at most 19800, at most 18600, at most 17500, at most 16900, or at most 16300. Moreover, the silane-modified polyether may have a number average molecular weight in a range including any of the minimum and maximum values noted herein. For example, the silane-modified polyether may have a number average molecular weight in a range from 4000 to 25000, 6500 to 19800, or in a range from 15600 to 17500.

In an embodiment, the silane-modified polyether may have a particular viscosity that may facilitate improved property and/or performance of the composition. In an example, the silane-modified polyether may have a viscosity of at least 0.2 Pa*s, at least 0.4 Pa*s, or at least 0.6 Pa*s. In another example, the viscosity of the silane-modified polyether may be at most 1 Pa*s, at most 0.8 Pa*s, or at most 0.7 Pa*s. Moreover, the viscosity of the silane-modified polyether may be in a range including any of the minimum and maximum values noted herein.

In an embodiment, the second component may be in a particular second content that may facilitate improved property and/or performance of the composition. In an example, the second content may be less than 10 wt % for the total weight of the composition, such as at most 9 wt %, at most 8 wt %, at most 7 wt %, at most 6 wt %, or at most 5 wt % for the total weight of the composition. In another example, the second component may be in a second content of at least 0.5 wt % for the total weight of the composition, such as at least 0.8 wt %, at least 1.2 wt %, at least 1.5 wt %, at least 1.7 wt %, at least 1.9 wt %, at least 2.0 wt %, at least 2.2 wt %, at least 2.53 wt %, or at least 2.5 wt % of the total weight of the composition. Moreover, the second component may be in the second content in a range including any of the minimum and maximum percentages noted herein. For example, the second content may be in a range from 0.5 wt % to 10 wt % or in a range from 1 wt % to 8 wt %. In a particular example, the second component may have a second content in a range including at least 1 wt % and at most 5 wt % of the composition. In a particular embodiment, the silane-modified polyether may be in any of the second contents noted herein.

In an embodiment, the silane-modified polyether may include an α-silane-terminated polyether. In an example, the silane-modified polyether may include a terminal dimethoxy silano group. In a particular example, the silane-modified polyether may include a silyl-methylcarbamate-terminated polyether. In a particular embodiment, the silane-modified polyether may include α-silane-terminated prepolymers that may have reactive alkoxysilyl groups that may be attached with a methylene spacer to an adjacent urethane unit. In a more particular embodiment, the silane-modified polyether may include dimethoxy(methyl) silyl-methylcarbamate-terminated polypropylene glycol.

In an embodiment, the composition may include a filler. In a particular embodiment, the filler may include a particular multi-model particle size distribution that may facilitate improved formation and/or property and performance of the composition. In another embodiment, the filler may include large particles and fine particles. In an example, large particles may have a particle size from 0.5 microns to 10 microns. In another example, small particles may have a particle size from 0.01 microns to 0.1 microns.

In another embodiment, the composition may include a first filler material having a particular first average particle size that may facilitate improved property and/or performance of the composition. In an example, the first filler may have a first average particle size of at least 0.8 microns, at least 1.1 microns, at least 1.5 microns, at least 1.8 microns, at least 2.2 microns, at least 2.5 microns, at least 2.7 microns, at least 3.0 microns, or at least 3.2 microns. Alternatively and/or additionally, the first average particle size may be at most 6.3 microns, at most 6.0 microns, at most 5.7 microns, at most 5.4 microns, at most 5.1 microns, at most 4.8 microns, at most 4.4 microns, at most 4.1 microns, at most 3.9 microns, at most 3.6 microns, or at most 3.3 microns. Moreover, the composition may include a first filler having a first average particle size in a range including any of the minimum and maximum values noted herein.

In an embodiment, the composition may include a second filler material having a second average particle size that may be different from the first average particle size. In another embodiment, the second filler material may have a particular second average particle size that may facilitate improved property and/or performance of the composition. In an example, the second average particle size of the second filler material may be at least 33 nm, at least 36 nm, at least 39 nm, at least 44 nm, at least 48 nm, at least 53 nm, at least 57 nm, at least 60 nm, at least 63 nm, at least 66 nm, at least 70 nm, at least 73 nm, or at least 76 nm. In another example, the second average particle size may be at most 140 nm, at most 130 nm, at most 110 nm, at most 95 nm, at most 91 nm, at most 88 nm, at most 86 nm, at most 82 nm, at most 80 nm, or at most 77 nm. Moreover, the second average particle size of the second filler may be in a range including any of the minimum and maximum values noted herein. Particle size may be measured utilizing a Horiba LA950 Laser Particle Analyzer or another functional equivalent instrument. Filler samples or a sample of the composition may be prepared by dispersing the powder in a suitable fluid (e.g., isopropanol) and run in an ultrasonic bath. The prepared sample may then be added drop-wise into the reservoir to measure the particle size distribution.

In another embodiment, the composition may include a particular particle size ratio P_{S1}/P_{S2} of the first filler material to the second filler material that may facilitate improved property and/or performance of the composition, wherein P_{S1} is the first average particle size of the first filler material and P_{S2} is the second average particle size of the second filler material. In an example, the ratio P_{S1}/P_{S2} may be at least 5:1, such as at least 10:1, at least 15:1, at least 20:1, at least 25:1, at least 35:1, at least 40:1, at least 45:1, at least 55:1, at least 60:1, at least 65:1, at least 70:1, or at least 75:1. In another example, the ratio P_{S1}/P_{S2} may be at most 150:1, at most 120:1, at most 100:1, at most 95:1, at most 90:1, at most 85:1, at most 80:1, at most 75:1, at most 70:1, at most 65:1, at most 60:1, at most 55:1, or at most 50:1. Moreover, the ratio P_{S1}/P_{S2} may be in a range including any of the minimum and maximum values noted herein.

In an embodiment, the composition may include a particular content ratio of C_{F1}/C_{F2} that may facilitate improved property and/or performance of the composition, wherein C_{F1} is a first content of the first filler, and C_{F2} is a second content of the second filler. In an example, the ratio C_{F1}/C_{F2} may be at least 0.4:1, at least 0.5:1, at least 0.6:1, at least 0.7:1, at least 0.8:1, at least 0.9:1, at least 1:1, or at least 1.1:1. In another example, the ratio C_{F1}/C_{F2} may be at most 2.9:1, at most 2.6:1, at most 2.4:1, at most 2.1:1, at most 1.9:1, at most 1.5:1, at most 1.3:1, or at most 1.1:1. Moreover, the ratio C_{F1}/C_{F2} may be in a range including any of the minimum and maximum values noted herein. For example, the ratio C_{F1}/C_{F2} may be in a range from 0.4:1 to 2.9:1, in a range from 0.5:1 to 1.7:1, or in a range from 0.7:1 to 1.3:1.

In an embodiment, the composition may include a particular total content of filler that may facilitate improved property and/or performance of the composition. In an example, the total content of filler may be at least 30 wt % for the total weight of the composition, such as at least 35 wt %, at least 37 wt %, at least 40 wt %, at least 42 wt %, at least 45 wt %, or at least 48 wt % for the total weight of the composition. In another example, the total content of the filler may be at most 68 wt % for the total weight of the composition, such as at most 64 wt %, at most 61 wt %, at most 57 wt %, at most 54 wt %, at most 51 wt %, or at most 49 wt % for the total weight of the composition. Filler content may be detected by using thermogravimetric analysis. TA TGA Q500 or a functional equivalent may be used. Moreover, the total content of filler may be in a range including any of minimum and maximum percentages noted herein.

In another embodiment, the composition may include a particular first filler content of the first filler material that may facilitate improved property and/or performance of the composition. In an example, the first filler content may be at least 14 wt % for a total weight of the composition, such as at least 16 wt %, at least 19 wt %, at least 22 wt %, at least 24 wt %, at least 27 wt %, or at least 30 wt % for a total weight of the composition. In another example, the first filler content may be at most 36 wt % for a total weight of the composition, such as at most 34 wt %, at most 31 wt %, at most 29 wt %, at most 27 wt %, or at most 25 wt % for a total weight of the composition. Moreover, the first filler content may be in a range including any of the minimum and maximum percentages noted herein. For example, the first filler content may be in a range from 14 wt % to 36 wt %, such as in a range from 20 wt % to 29 wt % for a total weight of the composition.

In another embodiment, the composition may include a particular second filler content of the second filler material that may facilitate improved property and/or performance of the composition. In an example, the second filler content may be at least 14 wt % for a total weight of the composition, such as at least 16 wt %, at least 19 wt %, at least 22 wt %, at least 24 wt %, at least 27 wt %, or at least 30 wt % for a total weight of the composition. In another example, the second filler content may be at most 36 wt % for a total weight of the composition, such as at most 34 wt %, at most 31 wt %, at most 29 wt %, at most 27 wt %, or at most 25 wt % for a total weight of the composition. Moreover, the second filler content may be in a range including any of the minimum and maximum percentages noted herein. For example, the second filler content may be in a range from 14 wt % to 36 wt %, such as in a range from 20 wt % to 29 wt % for a total weight of the composition.

In another embodiment, the filler may include an inorganic material, an organic material, a natural material, a synthetic material, or any combination thereof. An exemplary filler material may include calcium carbonate, silica, magnesium carbonate, carbon black, aluminum oxide, aluminum trihydrate, zinc borate, titanium oxide, iron oxide, or any combination thereof. A particular example of the filler material may include calcium carbonate, silica, carbon black, aluminum oxide, or any combination thereof. In a further embodiment, the first filler and the second filler may include the same material or different materials. In a particular example, the first filler and the second filler may include the same material. Elemental analysis with XRD may be used to analyze filler composition. Elemental analysis may be performed by conducting inductively coupled plasma atomic emission spectroscopy.

In another embodiment, the composition may include one or more additional components including, for example, a coupling agent, a catalyst, a rheological modifier, or any combination thereof. In a particular embodiment, the composition may include a rheological modifier. An example of the rheological modifier may include a plasticizer, diluent, or any combination thereof. In a particular example, the rheological modifier may include silicone oil, mineral oil, or the like, or any combination thereof. Exemplary silicone oil may include a silane-modified silicone resin, such as alkyl-terminated silicone resins. In another example, the rheological modifier may include a methyl-terminated silicone resin, a dimethyl-terminated silicone resin, or any combination thereof. In a particular example, the rheological modifier may include methyl-terminated polydimethylsiloxane, dimethyl-terminated polydimethylsiloxane, or any combination thereof.

In a further embodiment, the composition may include a particular content of the rheological modifier that may facilitate improved property and/or performance of the composition. In an example, the rheological modifier may be in a content of at least 1.3 wt % for a total weight of the composition, such as at least 1.5 wt %, at least 1.8 wt %, at least 2.2 wt %, at least 2.5 wt %, at least 2.8 wt %, at least 3.2 wt %, at least 3.5 wt %, at least 3.9 wt %, at least 4.2 wt %, at least 4.4 wt %, at least 4.5 wt %, at least 4.8 wt %, or at least 5.0 wt % for a total weight of the composition. In another example, the content of the rheology modifier may be at most 9.5 wt % for a total weight of the composition, such as at most 9.2 wt %, at most 8.7 wt %, at most 8.5 wt %, at most 8.2 wt %, at most 7.9 wt %, at most 7.6 wt %, or at most 7.2 wt % for a total weight of the composition. Moreover, the content of the rheology modifier may be in a range including any of the minimum and maximum percentages noted herein.

In a further embodiment, the composition may include a catalyst. In an example, the catalyst may be free of tin. In another example, the catalyst may include a titanium-containing compound comprising a titanium diisopropoxide bis(ethylacetoacetate), tetra-n-butyl-titanate, titanium (IV) isoproxide, or any combination thereof. In a further embodiment, the composition may include a particular content of the catalyst that may facilitate improved property and/or performance of the composition. In an example, the catalyst may be in a content of at least 0.1 wt % for a total weight of the composition, such as at least 0.3 wt %, at least 0.5 wt %, at least 0.7 wt %, at least 0.9 wt %, or at least 1.1 wt % for a total weight of the composition. In another example, the content of the catalyst may be at most 2.5 wt % for a total weight of the composition, such as at most 2.2 wt %, at most 2.0 wt %, at most 1.8 wt %, at most 1.6 wt %, at most 1.4 wt %, or at most 1.2 wt % for a total weight of the composition. Moreover, the content of the catalyst may be in a range including any of the minimum and maximum percentages noted herein.

In a further embodiment, the composition may include a silane coupling agent including, for example, (3-aminopropyl)triethoxysilane, (3-glycidoxypropyl)trimethoxy, vinyltrimethoxy silane, Diethoxy(3-glycidyloxypropyl)-methylsilane, [8-(Glycidyloxy)-n-octyl]-trimethoxysilane, methacryloxypropyl trimethoxysilane, tetracthoxysilane, 3-(2-Aminoethylamino)-propyltriethoxysilane, Bis[3-(trimethoxysilyl)-propyl]amine, Trimethoxy[3-(phenylamino)-propyl]silane, [3-(6-Aminohexylamino)-propyl]trimethoxysilane, octyltrimethoxysilane, 3-Glycidyloxypropyl(dimethoxy)-methylsilane, or any combination thereof. In another embodiment, the silane coupling agent may be in a content of up to 0.5 wt % for a total weight of the composition.

It may be worth noting that the composition of embodiments herein may have improved properties, such as one or more properties related to rheology of the composition, over time, such as less impacted by aging, and/or have improved performance including service life compared to conventional products. In an embodiment, the composition may demonstrate improved changes in one or more properties when aged. Such property may include complex viscosity, storage modulus, reactivity, vulcanization rate, or any combination thereof. For example, the composition may have reduced changes in storage modulus and/or complex viscosity over time. In another example, the composition may have a reduced decrease in reactivity and vulcanization rate over time. In certain instances, the composition may demonstrate increased vulcanization rate when aged.

In another particular embodiment, the composition may have a particular initial complex viscosity, final storage modulus, maximum value of the derivative of the storage modulus with respect to time, or any combination thereof, that may facilitate improved performance of the composition. As disclosed herein, initial complex viscosity, storage modulus, and vulcanization rate may be measured using the same test, an oscillation time sweep. A DHR-1 rheometer may be used to conduct time sweeps on a sample of a composition to assess its vulcanization performance with aging. The geometry for the set-up may be a parallel plate with a 25 mm top plate and a bottom Peltier plate to maintain a temperature of 20° C. Strain and frequency may be constants for the test at 0.5% and 1 Hz, respectively. The test time may be 12 hours.

As used herein, the term “initial” is intended to refer to the first point during the rheology measurement test, typically taken about 20 seconds after the test is started; and the term “final” is intended to refer to the last value taken during the rheology measurement, typically 12 hours after the test is started. A change of a property may be determined by using the formula, δp=[(P_{A}−P_{O})/P_{O}]×100%, wherein P_{A} may represent a property evaluated after aging of the composition, P_{O} may represent the property evaluated prior to aging of the composition, and δp may represent the changes there between.

In exemplary implementations, aging of the composition may be performed by exposing the composition to an aging condition. Aging conditions may be created by using an environmental chamber having a certain temperature and/or relative humidity (RH). In an example, the environmental chamber may be set at 20% RH or 50% RH or 70% RH. In another example, an aging condition may include a temperature of 20° C. to 25° C. or an elevated temperature, such as at least 40° C., at least 50° C., or at least 70° C. In a further example, exposure to an aging condition may be performed for at least 3 days, at least 7 days, at least 10 days, at least 14 days, or at least 21 days.

In a further embodiment, the composition may include a particular initial complex viscosity prior to aging of the composition that may facilitate improved property and/or performance of the composition. In an example, the initial complex viscosity prior to aging may be at most 3000 Pa·s, such as at most 2700 Pa·s, at most 2500 Pa·s, at most 2100 Pa·s, at most 1800 Pa·s, or at most 1500 Pa·s. In another example, the final complex viscosity prior to aging may be at least 700 Pa·s, at least 900 Pa·s, at least 1100 Pa·s, at least 1300 Pa·s, at least 1500 Pa·s, at least 1700 Pa·s, at least 2000 Pa·s, or at least 2200 Pa·s. Moreover, the initial complex viscosity prior to aging may be in a range including any of the minimum and maximum values noted herein. As disclosed herein, the initial complex viscosity prior to aging of the composition may also be referred to as original initial complex viscosity.

In another embodiment, the composition may include a particular initial viscosity after aging that may facilitate improved property and/or performance of the composition. The initial viscosity after aging of the composition may be determined after exposing the composition to an aging condition for a period of time. In an example, the composition may have an initial complex viscosity of at least 700 Pa·s after a 7-day exposure to 70% RH at 70° C., such as at least 900 Pa·s, at least 1100 Pa·s, at least 1300 Pa·s, at least 1500 Pa·s, at least 1700 Pa·s, at least 2000 Pa·s, or at least 2200 Pa·s after a 7-day exposure to 70% RH at 70° C. In another example, the initial complex viscosity may be at most 2700 Pa·s after a 14-day exposure to 70% RH at 70° C., such as at most 2500 Pa·s, at most 2300 Pa·s, at most 2100 Pa·s, at most 1800 Pa·s, or at most 1500 Pa·s after a 7-day exposure to 70% RH at 70° C. Moreover, the initial complex viscosity after a 7-day exposure to 70% RH at 70° C. may be in a range including any of the minimum and maximum values noted herein.

In a further example, the composition may have an initial complex viscosity of at least 500 Pa·s after a 14-day exposure to 70% RH at 70° C., such as at least 700 Pa·s, at least 1000 Pa·s, at least 1200 Pa·s, at least 1400 Pa·s, at least 1600 Pa·s, at least 1800 Pa·s, at least 2000 Pas, or at least 2200 Pa·s after a 14-day exposure to 70% RH at 20° C. to 25° C. In another example, the initial complex viscosity may be at most 3200 Pa·s after a 14-day exposure to 70% RH at 70° C., such as at most 3100 Pa·s, at most 2800 Pa·s, at most 2600 Pa·s, at most 2500 Pa·s, at most 2300 Pa·s, at most 2100 Pa·s, at most 1800 Pa·s, or at most 1500 Pa·s after a 14-day exposure to 70% RH. Moreover, the initial complex viscosity may be in a range including any of the minimum and maximum values noted herein after a 14-day exposure to 70% RH at 70° C.

In an embodiment, the composition may include a particular complex viscosity change that may facilitate improved performance of the composition. In an embodiment, the complex viscosity change after a 7-day exposure to 70% RH at 70° C. may be within ±15% of the original initial complex viscosity, such as within ±12% of the original initial complex viscosity, within ±10% of the initial complex viscosity, within ±8% of the original initial complex viscosity, within ±6% of an initial complex viscosity, within ±4% of the original initial complex viscosity, or within ±2% of the original initial complex viscosity of the composition. In another embodiment, the complex viscosity change may be within ±25% of the original initial complex viscosity after a 14-day exposure to 70% RH at 70° C., such as within ±23% of the original initial complex viscosity, within ±21% of the original initial complex viscosity, within ±19% of the original initial complex viscosity, within ±17% of the original initial complex viscosity, within ±15% of the original initial complex viscosity, within ±13% of the original initial complex viscosity, within ±11% of the original initial complex viscosity, within ±9% of the original initial complex viscosity, within ±7% of the original initial complex viscosity, or within ±5% of the original initial complex viscosity of the composition after a 14-day exposure to 70% RH at 70° C.

In another embodiment, the composition may include a particular final storage modulus that may facilitate improved property and/or performance of the composition. In this disclosure, the composition may be cured at 20° C. to 25° C. for 12 hours prior to determination of the final storage modulus. In an embodiment, the composition may have a particular original final storage modulus. As used herein, “the original final storage modulus” is intended to refer to the final storage modulus prior to aging of the composition. In an example, the original final storage modulus may be at least 0.08 MPa, such as at least 0.09 MPa, at least 0.10 MPa, at least 0.11 MPa, or at least 0.12 MPa. In another example, the original final storage modulus may be at most 0.18 MPa, such as at most 0.17 MPa, at most 0.16 MPa, at most 0.15 MPa, or at most 0.14 MPa. Moreover, the original final storage modulus may be in a range including any of the minimum and maximum values noted herein.

In an embodiment, the composition may have a particular final storage modulus. A final storage modulus may be determined after the cured composition is exposed to an aging condition. In an example, the final storage modulus after a 7-day exposure to 70% RH at 70° C. may be at least 0.07 MPa, such as at least 0.08 MPa, at least 0.09 MPa, at least 0.10 MPa, or at least 0.11 MPa. In another example, the final storage modulus after a 7-day exposure to 70% RH at 70° C. may be at most 0.15 MPa, such as at most 0.14 MPa, at most 0.13 MPa, at most 0.12 MPa, or at most 0.11 MPa. Moreover, the initial storage modulus may be in a range including any of the minimum and maximum values noted herein after a 7-day exposure to 70% RH at 70° C.

In an embodiment, the composition may have a final storage modulus of at least 0.03 MPa, after a 14-day exposure to 70% RH at 70° C., such as at least 0.05 MPa, at least 0.07 MPa, at least 0.08 MPa, or at least 0.09 MPa. Additionally or alternatively, the final storage modulus after a 14-day exposure to 70% RH at 70° C. may be at most 0.13 MPa, such as at most 0.12 MPa, at most 0.11 MPa, at most 0.09 MPa, at most 0.08 MPa, or at most 0.06 MPa. Moreover, the final storage modulus may be in a range including any of the minimum and maximum values noted herein after a 14-day exposure to 70% RH at 70° C.

In an embodiment, the storage modulus change may be within ±26% of the original final storage modulus after a 7-day exposure to 70% RH at 70° C., such as within ±23% of the original final storage modulus, within ±20% of the original final storage modulus, within ±18% of the original final storage modulus, within ±16% of the original final storage modulus, within ±14% of the original final storage modulus, within ±13% of the original final storage modulus, within ±11% of the original final storage modulus, within ±9% of the original final storage modulus, within ±7% of the original final storage modulus, within ±27% of the original final storage modulus, within ±5% of the original final storage modulus, or within ±3% of the original final storage modulus of the composition after a 7-day exposure to 70% RH at 70° C. In another embodiment, the storage modulus change may be within ±56% of the original final storage modulus after a 14-day exposure to 70% RH at 70° C., such as within ±53% of the original final storage modulus, within ±50% of the original final storage modulus, within ±48% of the original final storage modulus, within ±46% of the original final storage modulus, within ±44% of the original final storage modulus, within ±42% of the original final storage modulus, within ±38% of the original final storage modulus, within ±35% of the original final storage modulus, within ±31% of the original final storage modulus, within ±27% of the original final storage modulus, within ±23% of the original final storage modulus, within ±18% of the original final storage modulus, or within ±15% of the original final storage modulus of the composition after a 14-day exposure to 70% RH at 70° C.

In a further embodiment, the composition may include a particular vulcanization rate that may facilitate improved property and/or performance of the composition. In this disclosure, vulcanization rate may be the maximum value of (dG′/dt), wherein dG′ may be representative of the derivative of the storage modulus, and dt may be representative of the derivative of time. Vulcanization rate may be determined as follows. Time sweeps may be conducted on a composition sample at a temperature of 20° C. to 25° C., using a DHR-1 rheometer and a set of parallel plates with a 25 mm top plate and a bottom Peltier plate. Strain and frequency may be constants for the test at 0.5% and 1 Hz, respectively. The test time may be approximately 12 hours.

In a further embodiment, the first component may include a particular vulcanization rate that may facilitate improved property and/or performance of the composition. Vulcanization rate of the first component may be determined using the same test described with respect to the composition except that fillers are not included in the sample to be tested. The test time may be approximately 12 hours.

In an embodiment, the composition may include a particular vulcanization rate that may facilitate improved property and/or performance of the composition. In an example, the vulcanization rate prior to aging of the composition (also referred to as “original vulcanization rate”) may be at least 1.1×10⁻⁴ l/s, such as at least 1.3×10⁻ l/s⁴, at least 1.5×10⁻⁴ l/s, at least 1.8×10⁻⁴ l/s, or at least 2.0×10⁻⁴ l/s. In another example, the original vulcanization rate may be at most 4×10⁻⁴ l/s, such as at most 3.7×10⁻⁴ l/s, at most 3.5×10⁻⁴ l/s, at most 3.3×10⁻⁴ l/s, at most 3.1×10⁻⁴ l/s, at most 2.8×10⁻⁴ l/s, at most 2.5×10⁻⁴ l/s, at most 2.3×10⁻⁴ l/s, or at most 2.1×10⁻⁴ l/s. Moreover, the original vulcanization rate may be in a range including any of the minimum and maximum values noted herein.

In a further example, the composition may have a particular vulcanization rate after aging of the composition that may facilitate improved property and/or performance of the composition. In an example, the vulcanization rate may be at least 0.7×10⁻⁴ l/s after a 7-day exposure to 70% RH at 70° C., such as at least 0.9×10⁻⁴ l/s, at least 1.1×10⁻⁴ l/s, at least 1.3×10⁻⁴ l/s, at least 1.5×10⁻⁴ l/s, at least 1.8×10⁻⁴ l/s, or at least 2.0×10⁻⁴ l/s, at least 2.3×10⁻⁴ l/s, at least 2.6×10⁻⁴ l/s, at least 3.0×10⁻⁴ l/s, or at least 3.3×10⁻⁴ l/s after a 7-day exposure to 70% RH at 70° C. In another example, the vulcanization rate may be at most 4.5×10⁻⁴ after a 7-day exposure to 70% RH at 70° C., such as at most 4.3×10⁻⁴l/s, at most 4.1×10⁻⁴ l/s, at most 3.8×10⁻⁴ l/s, at most 3.5×10⁻⁴ l/s, at most 3.3×10⁻⁴ l/s, at most 3.1×10⁻⁴ l/s, at most 2.8×10⁻⁴ l/s, at most 2.5×10⁻⁴ l/s, at most 2.3×10⁻⁴ l/s, or at most 2.1×10⁻⁴ l/s after a 7-day exposure to 70% RH at 70° C. Moreover, the vulcanization rate after a 7-day exposure to 70% RH at 70° C. may be in a range including any of the minimum and maximum values noted herein.

In a further example, the composition may have a vulcanization at least 0.5×10⁻⁴ after a 14-day exposure to 70% RH at 70° C., such as at least 0.7×10⁻⁴, at least 0.9×10⁻⁴, at least 1.1×10⁻⁴, at least 1.3×10⁻⁴, at least 1.5×10⁻⁴, at least 1.7×10⁻⁴, at least 2.0×10⁻⁴, at least 2.3×10⁻⁴, or at least 2.5×10⁻⁴ after a 14-day exposure to 70% RH at 70° C. Additionally or alternatively, the vulcanization rate may be at most 4.8×10⁻⁴ after a 14-day exposure to 70% RH at 70° C., such as at most 4.6×10⁻⁴, at most 4.4×10⁴, at most 4.2×10⁴, at most 3.9×10⁻⁴, at most 3.7×10⁻⁴, at most 3.5×10⁻⁴, at most 3.3×10⁻⁴, at most 3.1×10⁻⁴, at most 2.8×10⁻⁴, at most 2.5×10⁻⁴, at most 2.3×10⁻⁴, at most 2.1×10⁻⁴, or 1.7×10⁻⁴ after a 14-day exposure to 70% RH at 70° C. Moreover, the vulcanization rate after a 14-day exposure to 70% RH at 70° C. may be in a range including any of the minimum and maximum values noted herein.

In a further embodiment, the composition may include a particular vulcanization rate change that may facilitate improved performance of the composition. In an embodiment, the composition may have a vulcanization rate change within ±15% of the original vulcanization rate after a 7-day exposure to 70% RH at 70° C., such as within ±12% of the original vulcanization rate, within ±10% of the original vulcanization rate, within ±8% of the original vulcanization rate, within ±6% of the original vulcanization rate, within ±4% of the original vulcanization rate, within ±2% of the original vulcanization rate, within ±1% of the original vulcanization rate, within ±0.5% of the original vulcanization rate, or within ±0.2% of the original vulcanization rate after a 7-day exposure to 70% RH at 70° C. In a further embodiment, the composition may have a vulcanization rate change within ±28% of the original vulcanization rate of the composition after a 14-day exposure to 70% RH at 70° C., such as within ±25% of the original vulcanization rate, within ±23% of the original vulcanization rate, within ±20% of the original vulcanization rate, within ±18% of the original vulcanization rate, within ±16% of the original vulcanization rate, within ±14% of the original vulcanization rate, within ±12% of the original vulcanization rate, within ±10% of the original vulcanization rate, within ±9% of the original vulcanization rate, within ±7% of the original vulcanization rate, within ±5% of the original vulcanization rate, within ±3% of the original vulcanization rate, or within ±1% of the original vulcanization rate after a 14-day exposure to 70% RH at 70° C.

In a further embodiment, the composition may have an increase in vulcanization rate after a 7-day exposure to 70% RH at 70° C. In an example, the increase may be at most 95% of the original vulcanization rate after a 7-day exposure to 70% RH at 70° C., such as at most 85%, at most 75%, at most 60%, at most 45%, or at most 35% of the original vulcanization rate after a 7-day exposure to 70% RH at 70° C. In another example, the increase in vulcanization rate may be at least 0.5% of the original vulcanization rate after a 7-day exposure to 70% RH at 70° C., such as at least 2%, at least 7%, at least 11%, at least 16%, or at least 20% of the original vulcanization rate after a 7-day exposure to 70% RH at 70° C. It is to be appreciated that increases in vulcanization rate can be within a range including any of the minimum and maximum values noted herein after a 7-day exposure to 70% RH at 70° C. In a further embodiment, the composition may have an increase in vulcanization rate after a 14-day exposure to 70% RH at 70° C. In an example, the increase may be at most 90% of the original vulcanization rate after a 14-day exposure to 70% RH at 70° C., such as at most 85%, at most 75%, at most 60%, at most 45%, or at most 35% of the original vulcanization rate after a 14-day exposure to 70% RH at 70° C. In another example, the increase in vulcanization rate may be at least 0.5% of the original vulcanization rate after a 14-day exposure to 70% RH at 70° C., such as at least 2%, at least 7%, at least 11%, at least 16%, or at least 20% of the original vulcanization rate after a 14-day exposure to 70% RH at 70° C. It is to be appreciated that increases in vulcanization rate can be within a range including any of the minimum and maximum values noted herein after a 14-day exposure to 70% RH at 70° C. After reading this disclosure, a skilled artisan appreciates that increased vulcanization rate indicates the composition may retain its reactivity when aged. In another example, the vulcanization rate may remain essentially the same after aging, such as a 7-day or a 14-day exposure to 70% RH at 70° C.

In an embodiment, the composition may have a reduced decrease in vulcanization rate when aged compared to conventional products. In an example, the decrease may be at most 35% of the original vulcanization rate after a 7-day exposure to 70% RH at 70° C., such as at most 21%, at most 17%, at most 14%, at most 11%, at most 9%, at most 7%, or at most 6% of the original vulcanization rate after a 7-day exposure to 70% RH at 70° C. In another example, the decrease in vulcanization rate may be at least 0.3% of the original vulcanization rate after a 7-day exposure to 70% RH at 70° C., such as at least 0.6%, at least 1.1%, at least 1.5%, at least 2.1%, at least 2.4%, at least 2.7%, at least 3.1%, at least 3.4%, at least 3.7%, at least 4.1%, or at least 4.4% of the original vulcanization rate after a 7-day exposure to 70% RH at 70° C. It is to be appreciated that decreases in vulcanization rate can be within a range including any of the minimum and maximum values noted herein after a 7-day exposure to 70% RH at 70° C. In a further example, the decrease may be at most 25% of the original vulcanization rate after a 14-day exposure to 70% RH at 70° C., such as at most 21%, at most 17%, at most 13%, at most 11%, or at most 9% of the original vulcanization rate after a 14-day exposure to 70% RH at 70° C. In another example, the decrease in vulcanization rate may be at least 1.5% of the original vulcanization rate after a 14-day exposure to 70% RH at 70° C., such as at least 2.3%, at least 2.7%, at least 3.1%, at least 3.6%, at least 4.2%, at least 4.7%, at least 5.3%, at least 5.9%, or at least 6.3% of the original vulcanization rate after a 14-day exposure to 70% RH at 70° C. It is to be appreciated that decreases in vulcanization rate can be within a range including any of the minimum and maximum values noted herein after a 14-day exposure to 70% RH at 70° C. It is to be appreciated that reduced decreases in the vulcanization rate with aging may indicate increased shelf life.

In an embodiment, the composition may be a one-part composition. In a further embodiment, the composition may be curable. In an example, the composition may be curable at room temperature, i.e., 20° C. to 25° C. In another example, the composition may be curable in air. In a further example, the composition may start to cure when in contact with air.

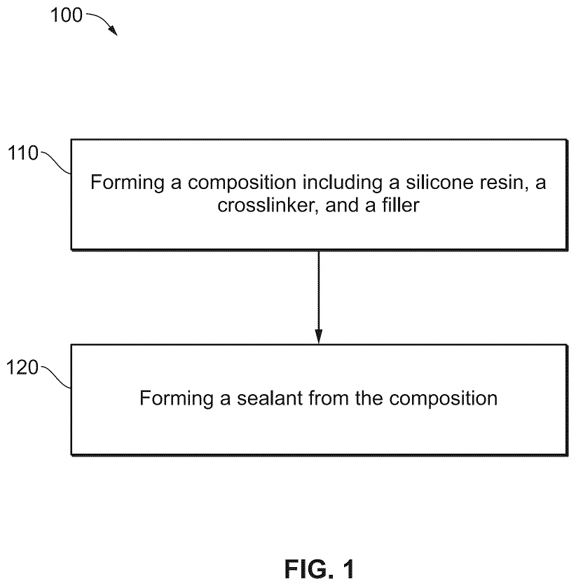

For purposes of illustration, FIG. 1 includes a diagram illustrating a process 100. The process 100 may include forming the composition described in embodiments herein at block 110. In a particular example, the components of the composition may be mixed to form a one-part composition. In another example, the composition may be stored in a container, such as a capped tube, for future use. A skilled artisan will appreciate that storage of the composition may be considered as aging of the composition.

In another embodiment, the process 100 may include forming a sealant from the composition at block 120. In an example, forming a sealant may include curing the composition. In an exemplary implementation, curing may be performed at 20° C. to 25° C. In a further example, curing may be performed in air. In another instance, curing of the composition may start when the composition may be exposed to air or otherwise in contact with air. In still another example, curing may be performed for a period of time, such as at least 6 hours, at least 8 hours, at least 10 hours, or at least 12 hours. Alternatively, or additionally, curing may be performed for at most 96 hours, such as at most 90 hours, at most 70 hours, at most 60 hours, at most 48 hours, at most 30 hours, at most 24 hours, at most 18 hours, at most 14 hours, or at most 12 hours. Moreover, curing may be performed for a time period including any of the minimum and maximum values noted herein. In a further embodiment, curing may include any of the vulcanization rate described in embodiments herein. In another embodiment, curing the composition may include a chemical reaction between the second component and the first component. In still another embodiment, curing may include forming a silicone-based sealant. After reading this disclosure, a skilled artisan may appreciate curing the composition may be performed after the composition may have been stored for a period of time. In an exemplary implementation, the composition may be extruded out of the container onto a surface and allowed to cure in air to form a sealant at the room temperature.

In a further embodiment, the sealant may include improved properties, such as tensile strength.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composition, comprising:
a first component comprising a silane-modified silicone resin, wherein the first component has a first content of greater than 30 wt % of the composition;
a second component comprising a silane-modified polyether; and
a filler comprising a multi-model particle size distribution.

Embodiment 2. The composition of embodiment 1, wherein the silane-modified silicone resin has a number average molecular weight of at most 60,000 g/mol, at most 55,000 g/mol, at most 50,000 g/mol, at most 45,000 g/mol, at most 40,000 g/mol, at most 35,000 g/mol, at most 30,000 g/mol, or at most 25,000 g/mol; and/or wherein the number average molecular weight of the silane-modified silicone resin is at least 15,000 g/mol, at least 20,000 g/mol, at least 25,000 g/mol, at least 30,000 g/mol, at least 35,000 g/mol, at least 40,000 g/mol, or at least 45,000 g/mol.

Embodiment 3. The composition of embodiment 1 or 2, wherein the silane-modified silicone resin comprises a terminal alkoxy silanol group.

Embodiment 4. The composition of embodiment 3, wherein the terminal alkoxy silanol group comprises a trimethoxy silanol group.

Embodiment 5. The composition of any one of embodiments 1 to 4, wherein the silane-modified silicone resin comprises repeating units of a formula of [(Si(CH₃)₂O].

Embodiment 6. The composition of any one of embodiments 3 to 5, wherein the terminal alkoxy silano group is directly bonded to an oxygen atom that is directly bonded to a silicon atom.

Embodiment 7. The composition of any one of embodiments 1 to 6, wherein the silane-modified silicone resin comprises trimethoxy-terminated polydimethylsiloxane.

Embodiment 8. The composition of any one of embodiments 1 to 7, wherein the first component comprises a vulcanization rate change within ±15% of an original vulcanization rate, when the first component is exposed to 70% RH at 70° C. for at least 14 days.

Embodiment 9. The composition of any one of embodiments 1 to 8, wherein the first content is at least 32 wt %, at least 34 wt %, at least 35 wt %, at least 37 wt %, at least 38 wt %, at least 40 wt %, at least 42 wt %, or at least 44 wt % of the composition; and/or wherein the first content is at most 56 wt % of the composition, at most 54 wt %, at most 53 wt %, at most 51 wt %, at most 49 wt %, at most 46 wt %, at most 45 wt %, or at most 43 wt % of the composition.

Embodiment 10. The composition of any one of embodiments 1 to 9, wherein the silane-modified polyether has a number average molecular weight of at least 4000, at least 5000, at least 6500, at least 7200, at least 8000, at least 9000, at least 10000, at least 11200, at least 12500, at least 13500, at least 14800, at least 15600, at least 16100, or at least 16500; and/or the silane-modified polyether has a number average molecular weight of at most 25000, at most 23600, at most 21700, at most 21000, at most 19800, at most 18600, at most 17500, at most 16900, or at most 16300.

Embodiment 11. The composition of any one of embodiments 1 to 10, wherein the second component has a second content of less than 10 wt % of the composition, at most 9 wt %, at most 8 wt %, at most 7 wt %, at most 6 wt %, or at most 5 wt %; and/or wherein the second component has a second content of at least 0.5 wt %, at least 0.8 wt %, at least 1.2 wt %, at least 1.5 wt %, at least 1.7 wt %, at least 1.9 wt %, at least 2.0 wt %, at least 2.2 wt %, at least 2.53 wt %, or at least 2.5 wt % of the composition.

Embodiment 12. The composition of any one of embodiments 1 to 11, wherein the second component has a second content in a range including at least 1 wt % and at most 5 wt % of the composition.

Embodiment 13. The composition of any one of embodiments 1 to 12, wherein the silane-modified polyether comprises an alpha-silane terminated polyether.

Embodiment 14. The composition of any one of embodiments 1 to 13, wherein the silane-modified polyether comprises a terminal dimethoxy silano group.

Embodiment 15. The composition of any one of embodiments 1 to 14, wherein the silane-modified polyether comprises a silyl-methylcarbamate-terminated polyether.

Embodiment 16. The composition of any one of embodiments 1 to 15, wherein the silane-modified polyether comprises dimethoxy(methyl) silyl-methylcarbamate-terminated polypropylene glycol.

Embodiment 17. The composition of any one of embodiments 1 to 16, wherein the filler comprises a first filler material having a first average particle size of at least 0.8 microns, at least 1.1 microns, at least 1.5 microns, at least 1.8 microns, at least 2.2 microns, at least 2.5 microns, at least 2.7 microns, at least 3.0 microns, or at least 3.2 microns; and/or wherein the first average particle size is at most 6.3 microns, at most 6.0 microns, at most 5.7 microns, at most 5.4 microns, at most 5.1 microns, at most 4.8 microns, at most 4.4 microns, at most 4.1 microns, at most 3.9 microns, at most 3.6 microns, or at most 3.3 microns.

Embodiment 18. The composition of any one of embodiments 1 to 17, wherein the filler comprises a second filler material having a second average particle size of at least 33 nm, at least 36 nm, at least 39 nm, at least 44 nm, at least 48 nm, at least 53 nm, at least 57 nm, at least 60 nm, at least 63 nm, at least 66 nm, at least 70 nm, at least 73 nm, or at least 76 nm and/or wherein the second average particle size is at most 140 nm, at most 130 nm, at least 110 nm, at most 95 nm, at most 91 nm, at most 88 nm, at most 86 nm, at most 82 nm, at most 80 nm, or at most 77 nm.

Embodiment 19. The composition of any one of embodiments 1 to 18, comprising a total content of the filler of at least 30 wt % of the composition, at least 35 wt %, at least 37 wt %, at least 40 wt %, at least 42 wt %, at least 45 wt %, or at least 48 wt % of the composition; and/or wherein the total content of the filler is at most 68 wt %, at most 64 wt %, at most 61 wt %, at most 57 wt %, at most 54 wt %, at most 51 wt %, or at most 49 wt % of the composition.

Embodiment 20. The composition of any one of embodiments 1 to 19, wherein the filler comprises calcium carbonate, silica, magnesium carbonate, carbon black, aluminum oxide, aluminum trihydrate, zinc borate, titanium oxide, iron oxide, or any combination thereof.

Embodiment 21. The composition of any one of embodiments 1 to 20, wherein the filler comprises a first filler comprising calcium carbonate, silica, magnesium carbonate, carbon black, aluminum oxide, aluminum trihydrate, zinc borate, titanium oxide, iron oxide.

Embodiment 22. The composition of embodiment 21, wherein the filler comprises a second filler comprising a same or different filler material than the first filler.

Embodiment 23. The composition of any one of embodiments 18 to 22, wherein a ratio of the first average particle size to the second average particle size is at least 5:1, at least 10:1, at least 15:1, at least 20:1, at least 25:1, at least 30:1, at least 35:1, or at least 40:1; and/or wherein the ratio of the first average particle size to the second average particle size is at most 90:1, at most 85:1, at most 80:1, at most 75:1, at most 70:1, at most 65:1, at most 60:1, at most 55:1, or at most 50:1.

Embodiment 24. The composition of any one of embodiments 1 to 23, comprising one or more of a coupling agent, a catalyst, a rheological modifier, or any combination thereof.

Embodiment 25. The composition of any one of embodiments 1 to 24, comprising a rheological modifier comprising a silane modified silicone resin comprising a dimethyl-terminated silicone resin, mineral oil or any combination thereof.

Embodiment 26. The composition of any one of embodiments 1 to 25, comprising a rheological modifier in a content of at least 1.3 wt % of the composition, at least 1.5 wt %, at least 1.8 wt %, at least 2.2 wt %, at least 2.5 wt %, at least 2.8 wt %, at least 3.2 wt %, at least 3.5 wt %, at least 3.9 wt %, at least 4.2 wt %, at least 4.4 wt %, at least 4.5 wt %, at least 4.8 wt %, or at least 5.0 wt % of the composition; and/or wherein the content of the plasticizer is at most 9.5 wt % of the composition, at most 9.2 wt %, at most 8.7 wt %, at most 8.5 wt %, at most 8.2 wt %, at most 7.9 wt %, at most 7.6 wt %, or at most 7.2 wt % of the composition.

Embodiment 27. The composition of any one of embodiments 1 to 26, comprising a catalyst comprising a titanium-containing compound comprising a titanium diisopropoxide bis(ethylacetoacetate), tetra-n-butyl-titanate, titanium (IV) isoproxide, or any combination thereof.

Embodiment 28. The composition of any one of embodiments 1 to 27, comprising a catalyst, wherein the catalyst is free of tin.

Embodiment 29. The composition of any one of embodiments 1 to 28, comprising a catalyst in a content of at least 0.1 wt % of the composition, at least 0.3 wt %, at least 0.5 wt %, at least 0.7 wt %, at least 0.9 wt %, or at least 1.1 wt % of the composition; and/or wherein the content of the catalyst is at most 2.5 wt % of the composition, at most 2.2 wt %, at most 2.0 wt %, at most 1.8 wt %, at most 1.6 wt %, at most 1.4 wt %, or at most 1.2 wt % of the composition.

Embodiment 30. The composition of any one of embodiments 1 to 29, comprising a silane coupling agent comprising (3-aminopropyl)triethoxysilane, (3-glycidoxypropyl)trimethoxy, vinyltrimethoxy silane, Diethoxy(3-glycidyloxypropyl)-methylsilane, [8-(Glycidyloxy)-n-octyl]-trimethoxysilane, methacryloxypropyl trimethoxysilane, tetraethoxysilane, 3-(2-Aminoethylamino)-propyltriethoxysilane, Bis[3-(trimethoxysilyl)-propyl]amine, Trimethoxy[3-(phenylamino)-propyl]silane, [3-(6-Aminohexylamino)-propyl]trimethoxysilane, octyltrimethoxysilane, 3-Glycidyloxypropyl(dimethoxy)-methylsilane, or any combination thereof.

Embodiment 31. The composition of any one of embodiments 1 to 30, comprising a silane coupling agent in a content of up to 0.5 wt % of the composition.

Embodiment 32. The composition of any one of embodiments 1 to 31, comprising an initial complex viscosity of at most 3000 Pa·s, at most 2700 Pa·s, at most 2500 Pa·s, at most 2100 Pa·s, at most 1800 Pa·s, or at most 1500 Pa·s; and/or wherein the initial complex viscosity is at least 700 Pa·s, at least 900 Pa·s, at least 1100 Pa·s, at least 1300 Pa·s, at least 1500 Pa·s, or at least 1700 Pa·s.

Embodiment 33. The composition of any one of embodiments 1 to 32, comprising a complex viscosity change within ±15% of an initial complex viscosity of the composition, a storage modulus change within ±20% of the final storage modulus of the composition after curing for 12 hours, a vulcanization rate change (maximum value of dG′/dt) within ±15% of an initial vulcanization rate of the composition, or a combination thereof when the composition is aged for 7 days at 70° C. and 70% RH.

Embodiment 34. The composition of any one of embodiments 1 to 33, comprising a complex viscosity change within ±20% of an original complex viscosity, a storage modulus change within ±50% of an original storage modulus, a vulcanization rate change within ±15% of an original vulcanization rate, or a combination thereof, when the composition is exposed to 50% RH at 20° C. to 25° C. for at least 7 days.

Embodiment 35. The composition of any one of embodiments 1 to 34, wherein the composition is curable at a temperature from 20° C. to 25° C.

Embodiment 36. A one-part curable composition, comprising the composition of any one of embodiments 1 to 35.

### EXAMPLES

### Example 1

Compositions CS1, CS2, S2, and S3 are prepared having the components noted in Tables 1 to 4, respectively.

TABLE 1
Composition CS1

| Material | wt % |
|---|---|
| Hydroxy-terminated PDMS | 45.03 |
| Dimethyl silicone oil | 2.83 |
| Trimethoxy(methyl)silane | 2.77 |
| Silane coupling agent (mixture) | 0.36 |
| Dupont TYZOR 726 (catalyst) | 1.15 |
| Nano Calcium carbonate-1 | 30.13 |
| Nano Calcium carbonate-2 | 17.73 |

Compositions CS2, S3, and S4 include the same base polymer, plasticizer, coupling agent, filler, and catalyst but different crosslinker. The base polymer is trimethoxy-terminated polydimethylsiloxane having the number average molecular weight of 43,100. Runhe 40K (available from Runhe Chemical) is an example of such polymer and used in all composition CS2, S3, and S4. The plasticizer is dimethyl-terminated silicone oil commercially available from Hubei Xingfa Chemicals Group Co., Ltd. The silane coupling agent is a mixture commercially available from Hubei Jianghan New Material Co., Ltd. The catalyst has the commercial designation of Tyzor 726. The crosslinker of composition CS2 is trimethoxy(methyl) silane commercially available from Gelest. The crosslinker of composition S3 is a silane-modified polyether having the number average molecular weight of 5,000. A polymer having the commercial designation of Geniosil® XT-120 from Wacker Chemie AG is used. The crosslinker of composition S4 is a silane-modified polyether having the number average molecular weight of 16,200. A polymer having the commercial designation of Geniosil® XT-50 from Wacker Chemie AG is used. Fillers are a mixture of filler 1, calcium carbonate having the average particle size of 3.2 microns, and filler 2, calcium carbonate having the average particle size of 76 nm. Fillers are commercially available and may be purchased from Huber Engineered Materials, Omya AG, or Xuanchen Xinweihua Chemical Technology Co. Ltd.

TABLE 2
Composition CS2

| Material | Wt % |
|---|---|
| Base polymer | 45.03 |
| Plasticizer | 2.83 |
| Crosslinker | 2.72 |
| Silane coupling agent | 0.36 |
| Catalyst | 1.13 |
| Filler 1 | 24.38 |
| Filler 2 | 24.38 |

TABLE 3
Composition S4

| Material | Wt % |
|---|---|
| Base polymer | 42.03 |
| Plasticizer | 5.00 |
| Crosslinker | 2.72 |
| Silane coupling agent | 0.36 |
| Catalyst | 1.13 |
| Filler 1 | 24.38 |
| Filler 2 | 24.38 |

TABLE 4
Composition S3

| Material | Wt % |
|---|---|
| Base polymer | 44.25 |
| Plasticizer | 3.5 |
| Crosslinker | 2.72 |
| Silane coupling agent | 0.36 |
| Catalyst | 1.13 |
| Filler 1 | 24.38 |
| Filler 2 | 24.38 |

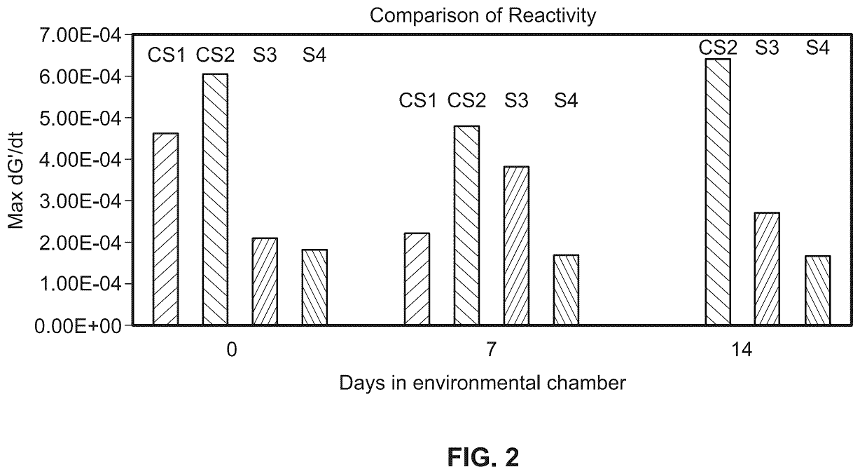

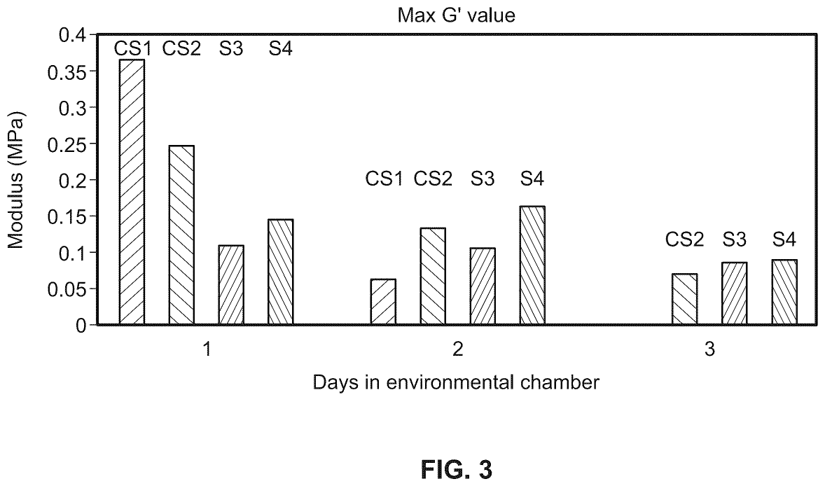

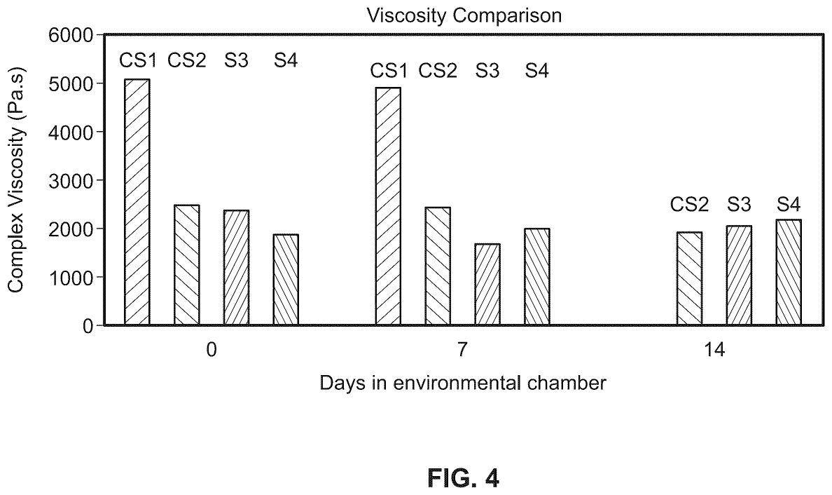

Compositions CS1, CS2, S3, and S4 are tested for vulcanization rate, final storage modulus, and initial complex viscosity before and after exposures to 70% RH at 70° C. for 7 days and 14 days respectively, as described in embodiments herein. The test results are illustrated in FIGS. 2 to 4 and summarized in Tables 5-8.

As illustrated in FIGS. 2 to 4, the X-axis depicts days of aging of the composition before the tests. “0” is used for tests of the compositions without aging. “7” and “14” is used for tests conducted samples after aging for 7 and 14 days, respectively prior to testing.

TABLE 5
Testing results of composition CS1

| | Max | | Complex | | | |
|---|---|---|---|---|---|---|
| | dG′/dT | % | Viscosity | % | Final G′ | % |
| Day | (1/s) | Decrease | (Pa*s) | Decrease | (Mpa) | Decrease |
| 0 | 4.62E−04 | / | 5083.72 | / | 0.367 | / |
| 7 | 2.21E−04 | 52.16% | 4920.47 | 3.21% | 0.0642 | 82.51% |
| 14 | Did not | / | / | / | / | / |
| | cure | | | | | |

TABLE 6
Testing results of composition CS2

| | | | Complex | | | |
|---|---|---|---|---|---|---|
| | Max dG′/dT | | Viscosity | | Final G′ | |
| Day | (1/s) | % Decrease | (Pa*s) | % Decrease | (Mpa) | % Decrease |
| 0 | 0.000606 | | 2475.45 | | 0.248 | |
| 7 | 4.84E−04 | 20.18% | 2409.76 | 2.65% | 0.135 | 45.56% |
| 14 | 6.45E−04 | −6.44% | 1931.7 | 21.97% | 0.07 | 71.77% |

Compared to Day 0, Sample CS1 demonstrates a significant decrease in the vulcanization rate, 52.16%, the final storage modulus, 82.51%, and a slight decrease of 3.21% in the initial complex viscosity after aging for 7 days and fails to cure after aging for 14 days. Aging at 70% RH at 70° C. for 7 days and 14 days is equivalent to a shelf time (i.e., at room temperature in air) of 6 months and 12 months, respectively. It is suggested that Composition CS1 may have a shelf life significantly shorter than 1 year, as the composition fails to cure after aging at 70% RH and 70° C. for 14 days, and because of the significant changes in the final storage modulus and vulcanization rate when aged at 70% RH and 70° C. for 7 days.

Compared to Day 0, Composition CS2 demonstrates a significant decrease in the vulcanization rate, 20.18%, a slight decrease of 2.65% in the initial viscosity, and a significant decrease, 45.56%, in the final storage modulus after aging for 7 days; and an increase of 6.44% in the vulcanization rate, a significant decrease of 21.97% in the initial complex viscosity, and a significant decrease of 71.77% in the final storage modulus after aging for 14 days. It can be observed performance of Composition CS2 improves over CS1, but significantly decreased final storage modulus after aging for 7 and 14 days respectively, suggests a significant reduction in strength of the seal. The overall test data suggests performance of Composition CS2, e.g., strength, may decrease significantly with aging over time and aging may have a significant adverse effect on the shelf life of the composition.

TABLE 7
Testing results of composition S3

| | Max | | Complex | | | |
|---|---|---|---|---|---|---|
| | dG′/dT | % | Viscosity | % | Final G′ | % |
| Day | (1/s) | Decrease | (Pa*s) | Decrease | (Mpa) | Decrease |
| 0 | 2.10E−04 | | 2400 | | 0.11 | |
| 7 | 3.85E−04 | −83.33% | 1662.5 | 30.73% | 0.105 | 4.55% |
| 14 | 2.76E−04 | −31.43% | 2070 | 13.75% | 0.086 | 21.82% |

TABLE 8
Testing results of Composition S4

| | Max | | Complex | | | |
|---|---|---|---|---|---|---|
| | dG′/dT | % | Viscosity | % | Final G′ | % |
| Day | (1/s) | Decrease | (Pa*s) | Decrease | (Mpa) | Decrease |
| 0 | 1.82E−04 | | 1857.34 | | 0.147 | |
| 7 | 1.73E−04 | 5.22% | 2001.52 | −7.76% | 0.165 | −12.63% |
| 14 | 1.67E−04 | 8.24% | 2192.76 | −18.06% | 0.091 | 37.88% |

Compared to Day 0, Sample S3 appears to have a significant increase in the vulcanization rate, e.g., 83.33%, a significant decrease in the initial complex viscosity, e.g., 30.73%, and a slight change in the final storage modulus after aging for 7 days; and a significant increase in the vulcanization rate, e.g., 31.43%, a decrease of 13.75% in the initial complex viscosity, and a decrease in the final storage modulus, e.g., 21.82% after aging for 14 days. Composition S3 may have improved property and/or performance over Compositions CS1 and CS2, e.g., initial complex viscosity and final storage modulus, when aged over time. Decreases in initial complex viscosity and final storage modulus are considered acceptable. Increased vulcanization rates may suggest improved shelf life of the composition when aged over time.

Compared to Day 0, Sample S4 has a 5.22% decrease in the vulcanization rate, a 7.76% increase in the initial complex viscosity, and a 12.63% increase in the final storage modulus after aging for 7 days; and a decrease of 8.24% in the vulcanization rate, an increase of 18.06% in the initial complex viscosity, and a decrease of 37.88% in the final storage modulus after aging for 14 days. Sample S4 demonstrates improved stability in the tested properties compared to Samples CS1 and CS2, which suggests improved performance of Sample S4 over Samples CS1 and CS2 over time. The slight changes in the vulcanization rates suggest the composition is capable of retaining reactivity, which suggests improved shelf life of Sample S4.

### Example 2

Reactivity of different silane-modified polydimethylsiloxane polymers is tested with aging. Polymers are aged in an environmental chamber having 70% RH at 70° C. for 7 and 14 days, respectively. Reactivity is represented by the vulcanization rate measured according to embodiments herein. A polymer having a minimized change in vulcanization rate is expected to retain higher reactivity over aging. The original vulcanization rate is measured prior to aging (referred to as “Day 0”). The vulcanization rates of aged polymers are measured after aging for 7 days (referred to as “Day 7”) and 14 days (referred to as “Day 14”), respectively. Changes in vulcanization rates on Day 7 and D14 compared to Day 0 are determined and included in Table 9 below. Negative percentages indicate decreases and positive percentages indicate increases in the vulcanization rate.

TABLE 9

| Polymer | Changes on Day 7 | Changes on Day 14 |
|---|---|---|
| 1. Hydroxyl-terminated | −89% | −92% |
| PDMS | | |
| 2. Trimethoxy-terminated | −13% | −15% |
| PDMS having the number | | |
| average molecular weight of | | |
| 43100 | | |
| 3. Trimethoxy-terminated | −65% | −70% |
| PDMS having the number | | |
| average molecular weight of | | |
| 38700 | | |
| 4. Trimethoxy-terminated | −60% | −72% |
| PDMS having the number | | |
| average molecular weight of | | |
| 35700 | | |
| 5. Dimethoxy-terminated | −71% | −78% |
| trimethoxy-pendant PDMS | | |
| 6. Dimethoxy-terminated | 3% | 55% |
| PDMS | | |

It can be observed that polymer 2, trimethoxy-terminated PDMS having the number average molecular weight of 43100, has significantly reduced decreases in vulcanization rate/reactivity compared to the other polymers when aged for an extended period of time.

### Example 3

Compositions are prepared using different filler materials as noted in Table 10. All the compositions have the same components and contents thereof as Composition CS1 except for fillers. The total content of the filler is the same for all the compositions. Filler 1 is calcium carbonate having an average particle size of 3 microns, and filler 2 is calcium carbonate having an average particle size of 0.04 microns.

Properties of the compositions are evaluated and included in Table 10. It is observed mixing of compositions 1 to 5 tends to be difficult, and high viscosity of the compositions 1 to 5 renders lower extrusion rates. Tensile strength of cured compositions 6 and 8 are measured according to ASTM D412. Composition 6 demonstrates tensile strength of 157 psi, composition 8 demonstrates marginal tensile strength.

TABLE 10

| | Content ratio of | Extrusion | Viscosity |
|---|---|---|---|
| Composition | Filler 1 to Filler 2 | Rate g/min | (Centipoise) |
| 1 | 0 (only filler 2 is | 23 | 330000 |
| | used) | | |
| 2 | 1:33 | 31 | 312000 |
| 3 | 1:20 | 48 | 282000 |
| 4 | 1:9 | 92 | 177000 |
| 5 | 1:3 | 107 | 182000 |
| 6 | 1:1 | 280 | 46000 |
| 7 | 3:1 | 440 | 27000 |
| 8 | /(only filler 1 is | 620 | 19000 |
| | used) | | |

The foregoing embodiments are directed to compositions, and particularly room temperature vulcanizing compositions for silicone sealants, which represent a departure from the state-of-the-art. The compositions of the embodiments herein utilize a combination of features that facilitate unexpected improvement in performance over conventional sealant compositions. Not wishing to be bound to any theory, improvement in performance may be facilitated by utilizing a particular combination of the first component, a silane-modified silicone polymer, and the second component, a silane-modified polyether, in combination with filler particle size distribution, ratios of particle sizes and/or ratios of contents between different filler materials, or any combination thereof. For example, the particular combination of the first and second components may facilitate improved service life, such as minimized changes in the vulcanization rate and thermal properties of the composition with aging. Filler materials of embodiments herein may facilitate formation of the composition having improved viscosity and homogeneity, optimal extrusion rate, or any combination thereof.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composition, comprising:
a first component comprising a silane-modified silicone resin, wherein the first component has a first content of greater than 30 wt % of the composition;
a second component comprising a silane-modified polyether; and
a filler comprising a multi-model particle size distribution.

2. The composition of claim 1, wherein the silane-modified silicone resin has a number average molecular weight of at most 60,000 g/mol and at least 15,000 g/mol.

3. The composition of claim 1, wherein the silane-modified silicone resin comprises a terminal alkoxy silanol group.

4. The composition of claim 3, wherein the terminal alkoxy silanol group comprises a trimethoxy silanol group.

5. The composition of claim 1, wherein the silane-modified silicone resin comprises repeating units of a formula of [(Si(CH₃)₂O].

6. The composition of claim 1, wherein the silane-modified silicone resin comprises trimethoxy-terminated polydimethylsiloxane.

7. The composition of claim 1, wherein the first component comprises a vulcanization rate change within ±15% of an original vulcanization rate, when the first component is exposed to 70% RH at 70° C. for at least 14 days.

8. The composition of claim 1, wherein the first content is at least 32 wt % and at most 56 wt % of the composition.

9. The composition of claim 1, wherein the silane-modified polyether has a number average molecular weight of at least 4000 and at most 25000.

10. The composition of claim 9, wherein the second component has a second content of less than 10 wt % of the composition.

11. The composition of claim 1, wherein the second component has a second content in a range including at least 1 wt % and at most 5 wt % of the composition.

12. The composition of claim 1, wherein the silane-modified polyether comprises an alpha-silane terminated polyether.

13. The composition of claim 1, wherein the silane-modified polyether comprises a terminal dimethoxy silano group.

14. The composition of claim 1, wherein the silane-modified polyether comprises a silyl-methylcarbamate-terminated polyether.

15. The composition of claim 1, wherein the filler comprises a first filler material having a first average particle size of at least 0.8 microns and at most 6.3 microns and a second filler material having a second average particle size of at least 33 nm.

16. The composition of claim 1, comprising a total content of the filler of at least 30 wt % of the composition.

17. The composition of claim 1, wherein the filler comprises calcium carbonate, silica, magnesium carbonate, carbon black, aluminum oxide, aluminum trihydrate, zinc borate, titanium oxide, iron oxide, or any combination thereof.

18. The composition of claim 1, wherein a ratio of a first average particle size to a second average particle size is at least 5:1 and at most 90:1.

19. The composition of claim 1, wherein the composition is curable at a temperature from 20° C. to 25° C.

20. A one-part curable composition, comprising the composition of claim 1.
